(19) United States
(12) Patent Application Publication
(10) Pub. No.: US 2023/0351034 A1
(43) Pub. Date: Nov. 2, 2023

(54) METHODS AND SYSTEMS FOR ENHANCED COLLABORATION

(71) Applicant: COMCAST CABLE COMMUNICATIONS, LLC, Philadelphia, PA (US)

(72) Inventor: Amit Parikh, Princeton, NJ (US)

(21) Appl. No.: 17/734,898

(22) Filed: May 2, 2022

(51) Int. Cl. G06F 21/62; G06F 16/176

(52) U.S. Cl. CPC G06F 21/6218; G06F 16/176

(57) ABSTRACT

Methods, systems, and apparatus are described herein for enhanced collaboration during a video conference. A computing device may determine that a first user device and a second user device are accessing a data file and that the second user has shared the data file with a third user device. The computing device may send an alert to a first computing device indicating the second user device is sharing the data file.

### BACKGROUND

Multi-user collaboration on documents is often necessary in industry, academics and other endeavors. For example, software developers may need to collaborate while writing a software architecture document. Students may need to collaborate on a presentation or academic paper. Collaboration on a document is often accomplished by editing the document sequentially (e.g., one collaborator can edit the document at a time). Alternatively, collaboration on a document can be accomplished by having each collaborator edit a different version of the document and then merging the documents together. Further, collaboration on a document may be live (e.g., real-time) wherein multiple users may edit the document at the same time (simultaneously). Situations may arise where a collaborator may desire to permit a non-collaborator to view such a document. Solutions are available to share or otherwise broadcast the contents of a screen (or of a specific application program) of one computing device to another computing device. Still, issues exist with current systems that allow collaboration and sharing of documents.

### SUMMARY

It is to be understood that both the following general description and the following detailed description is merely an example and is explanatory only and is not restrictive. Methods, systems, and apparatuses for enhanced collaboration are described. When a plurality of users (e.g., user accounts) have access to a data file (e.g., collaborators), a first user of the plurality of users may share the data file with a second user (e.g., a non-collaborator). A third user of the plurality of users may be alerted that the data file is being shared with the second user.

Other examples and configurations are possible. Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles:

FIG. 1 is a block diagram of an example system and network;

FIGS. 2A-2C show example share alerts;

FIGS. 3A-3C show example interfaces;

FIG. 4 is a flowchart of an example method;

FIG. 5 is a flowchart of an example method;

FIG. 6 is a flowchart of an example method;

FIG. 7 is a flowchart of an example method;

FIG. 8 is a flowchart of an example method;

FIG. 9 is a flowchart of an example method; and

FIG. 10 is a block diagram of an example computing device.

### DETAILED DESCRIPTION

Before the present techniques are disclosed and described, it is to be understood that this disclosure is not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” or “example” means “an example of” and is not intended to convey an indication of a preferred or ideal embodiment. “Such as” is not used in a restrictive sense, but for explanatory purposes.

Disclosed are components that can be used to perform the disclosed content analysis and storage techniques. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present systems and methods may be understood more readily by reference to the following detailed description of preferred embodiments and the examples included therein and to the Figures and their previous and following description.

As will be appreciated by one skilled in the art, the content analysis and storage techniques may take the form of an entirely hardware embodiment, an entirely software embodiment, or an embodiment combining software and hardware aspects. Furthermore, the content analysis and storage techniques may take the form of a computer program product on a computer-readable storage medium having computer-readable program instructions (e.g., computer software) embodied in the storage medium. More particularly, the present content analysis and storage techniques may take the form of web-implemented computer software. Any suitable computer-readable storage medium may be utilized including hard disks, CD-ROMs, optical storage devices, or magnetic storage devices.

Embodiments are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

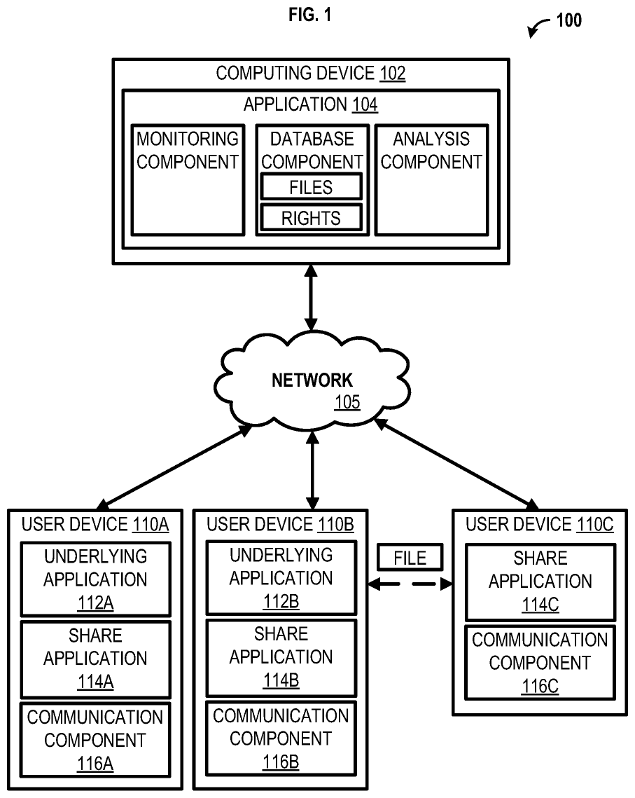

FIG. 1 shows an example system 100 in which the present methods and systems may operate. One skilled in the art will appreciate that provided herein is a functional description and that the respective functions can be performed by software, hardware, or a combination of software and hardware. The system 100 may facilitate enhanced collaboration.

The system 100 may comprise a computing device 102, a network 105, and one or more user devices. The one or more user devices may be configured to communicate with each other and/or with the computing device 102 through the network 105. While only user devices 110A, B, C are shown, it is to be understood the system 100 may comprise any number of user devices. Likewise, while only a single computing device 102 is shown, it is to be understood that the system 100 may comprise any number of computing devices.

The network 105 may comprise any telecommunications network such as the Internet or a local area network. Other forms of communications can be used such as wired or wireless telecommunication channels, for example. The network 105 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof.

The computing device 102 may comprise a computer, a server, a laptop, a smart phone, or the like. The computing device 102 may be configured to send, receive, generate, store, or otherwise process data. The computing device 104 may comprise an application 104. The application 104 may comprise a monitoring component, a database component, and an analysis component. While FIG. 1 shows the various components as part of the application 104 housed on the computing device 102, FIG. 1 is merely exemplary and the various components may be housed on one or more disparate devices in communication with each other via the network 105. The database component may be configured to store one or more data files and/or one or more rights. Each data file of the one or more data files may be associated with a data file identifier. For example, a first data file of the one or more data files may be associated with a first data file identifier of the one or more data file identifiers and a second data file of the one or more data files may be associated with a second data file identifier of the one or more data files. The one or more rights may be associated with the one or more data files and further associated with the one or more user devices. For example, the database component may comprise a document management system (DMS) configured to store and manage the one or more data files (e.g., documents). For example, the database component may be configured to store the one or more rights associated with the one or more data files.

The application 104 may be configured to interface, for example through one or more Application Program Interfaces (APIs), with one or more applications and/or programs. For example, the application 104 may be configured to interface with and/or otherwise interact with the one or more underlying applications and/or one or more share applications. The one or more underlying applications may comprise one or more native applications hosted on the user device 110A and/or the one or more applications may comprise browser-based applications hosted on a remote computing device. For example, the one or more underlying applications may comprise one or more word processing applications (e.g., MICROSOFT WORD, GOOGLE DOCS, or the like), one or more data entry or processing applications (e.g., MICROSOFT EXCEL, GOOGLE SHEETS, or the like), one or more content presentation applications (e.g., MICROSOFT POWERPOINT, GOOGLE SLIDES, or the like), one or more web browsers, or any other applications. The one or more share applications may comprise one or more applications configured to share (e.g., send, receive, output, generate, store, or otherwise process) data. For example, the one or more share applications may comprise MICROSOFT TEAMS, GOOGLE WORKSPACE, SKYPE, ZOOM, SLACK, AIM, FLOCK, TWIST, GOTOMEETING, DISCORD, combinations, or the like.

The one or more user devices may comprise one or more computers, laptops, smartphones, or other user devices. Each user device of the one or more user devices may be associated with one or more user device identifiers. The one or more user device identifiers may comprise a string of letters, numbers, characters, or the like. For example, the one or more user device identifiers may comprise one or more media access control (MAC) addresses. The one or more user device identifiers may indicate (e.g., be associated with) one or more user accounts. The one or more user accounts may be subscription accounts, paid accounts, or the like. For example, a first user device 110A of the one or more user devices may be associated with a first user device identifier and a second user device 110B of the one or more user devices may be associated with a second user device identifier of the one or more user device identifiers.

Each user device of the one or more user devices may be configured with (e.g., comprise, configured to run) one or more applications. The one or more applications may comprise, for example, an underlying application and/or a share application. For example, first user device 110A of the one or more user devices may comprise a first underlying application 112A, a first share application 114A, and a first communications component 116A. The second user device 110B may comprise a second underlying application 112B, a second share application 114B, and a second communications component 116B. A third user device 110C may comprise a third share application 114C and a third communications component 116C. The one or more underlying applications may be configured to access the one or more data files stored in the database component. For example, if a first data file of the one or more data files comprises a word document, a first underlying application 112A may be configured as a word processing application such as Microsoft Word, Google Docs, or Apple's Pages. While the aforementioned example refers to word processing applications, it is to be understood that the one or more data files and the one or more underlying applications may comprise any type of data files in any format, including but not limited to, spreadsheets, PowerPoints, XML files, software development applications, etc.

The one or more rights may comprise, for example, one or more access rights, one or more edit rights, one or more viewing rights, one or more sharing rights, or any other rights associated with the one or more data files and/or the one or more user devices. For example, the first user device may be associated with a first user (e.g., associated with a first user account). For example, the second user device may be associated with a second user (e.g., a second user account). For example, the first user, upon initiation of either or both of the underlying application and/or the share application, may login with a user identifier or other credentials. As such, the first user may be associated with a first access right to access the first data file, a first edit right to edit the first data file, and a first sharing right to share the data file. The first access right may be configured to allow the first user to, for example, view and/or download (e.g., store locally) the first data file. The first edit right may be configured to allow the first user to make changes to the first data file such as editing the first data file. For example, if the first data file comprises a word processing document, the first edit right may be configured to allow the first user to edit text of the word processing document. The first sharing right may be configured to allow the first user to share the first data file. Sharing the first data file may comprise sending the first data file, displaying the first data file (e.g., on a display associated with the first user device 110A), and/or causing another device (such as the second user device 110B) to display the first data file (e.g., through a video-conference or screen share configuration).

The second user may be associated with second access rights to access the first data file, a second edit right, and a second share right. The second access right may be configured to allow the second user to, for example, view and/or download (e.g., store locally) the first data file. The second edit right may be configured to allow the second user to make changes to the first data file such as editing the first data file. For example, if the first data file comprises a word processing document, the second edit right may be configured to allow the second user to edit text of the word processing document. The second sharing right may be configured to allow the second user to share the first data file. Sharing the first data file may comprise sending the first data file, displaying the first data file (e.g., on a display associated with the second user device 110A), and/or causing another device (such as a third user device 110C) to display the first data file (e.g., through a video-conference or screen share configuration).

The monitoring component may be configured to send and receive data to and from the one or more user devices and/or to and from the database component and the analysis component. One or more data file actions may be determined. For example, the monitoring component may be configured to determine one or more data file actions. The one or more data file actions may comprise, for example, one or more access actions, one or more edit actions, one or more share actions, combinations thereof, and the like. For example, either or both of the one or more user devices or the database component may send an indication to the monitoring component that a user (e.g., the first user or the second user) has taken a data file action of the one or more data file actions with respect to the one or more data files.

An indication from a user device that a user has accessed a data file may be received. For example, the monitoring component may be configured to receive an indication, from a user device of the one or more user devices, that a user has accessed a data file of the one or more data files. Similarly, the monitoring component may be configured to receive a notification from the first underlying application 112A that the first user has accessed a data file. It may be determined that two devices are simultaneously accessing the data file. For example, the monitoring component may determine that two devices are simultaneously accessing the data file. For example, the monitoring device may determine the first user and the second user are simultaneously accessing the first data file. For example, the first user may access the first date file at a first time. The first user may share the first data file with the second user. Sharing the first data file with the second user may comprise sending the first data file to the second user. If the first user and the second user are in a videoconference, sharing the first data file with the second user may comprise selecting the first data file for sharing with the second user. For example, the first user and the second user may be participating in a videoconference. The first user may execute a share action. The share action may comprise sharing the data file. Sharing the data file may comprise selecting the data file and selecting a share option, as opposed to simply sharing a display of the first user device that is presently displaying the first data file. Based on the first user sharing the first data file with the second user, the computing device 102 may receive a first share indication.

Based on receiving the first share indication, it may be determined that the first user has shared the data file the second user. For example, the monitoring component may determine the first user has shared the data file with the second user. The second user may access the data file. Based on the second user accessing the data file, the monitoring component may cause an alert to be output in the data file wherein the alert is configured to indicate either or both of the first user and/or the second user are editing, viewing, or otherwise interacting with (e.g., “in”) the data file.

The second user may access the first data file at a second time. Accessing the first data file may comprise viewing the data file or interacting with (e.g., editing or otherwise being “in” the first data file). The monitoring component may determine the second user accessed the first data file and may send, to the first user device 110A, a first message. The first message may be configured to cause output of an alert. For example, the first message may cause an output of an icon, image, text, pictograph, or the like, in the first data file, on a display of the first user device 110A. The icon may or may not appear on a display of the second user device 110B.

For example, if while, accessing the first data file, the first user edits the first data file, the monitoring component may receive a notification from either or both of the first user device 110A and/or the database component that the first date file has been edited (e.g., that an edit action has been initiated, completed, saved, etc.).

It may be determined that the second user has initiated a share action of the first data file with a third user. For example, the monitoring component may be configured to determine, for example, that the second user has initiated a share action of the first data file with a third user. The monitoring component may receive, for example, from the share application 114B, a second share indication that the second user has initiated the share action, for example, in an attempt to share/display the first data file with the third user. For example, the second user may be accessing the first data file, wherein accessing the first data file comprises displaying the first data file on a display associated with the second user device 110B. The share action may comprise for example, sending the first data file to the third user device 110C, or causing the third user device 110C to display the first data file. For example, the share action may comprise a screen share.

Based on determining that the second user has initiated the share action, the monitoring component may send, to the first user device 110A, a second message configured to cause, on the display of the first user device 110A (e.g., “in” or “on” the first data file), an alert indicating the second user has initiated the share action.

The one or more data file actions may be associated with the one or more rights. The one or more rights may be associated with the one or more user devices. The one or more rights may comprise, for example, one or more access rights, one or more edit eights, one or more share rights, combinations thereof, and the like. For example, the one or more rights may indicate actions allowed to be taken with respect to the one or more data files by the one or more user devices. For example, a first edit right may indicate the first user is allowed to edit the first data file while a second edit right may indicate the second user is allowed to edit the data file. For example, a first share right may indicate the first user is allowed to share (e.g., send, cause display of) the first data file, while a second share right may indicate the second user is not allowed to share the first data file.

It may be determined that a user device of the one or more user devices is attempting an action. The action may be compared with an associated right of the one or more rights. For example, the monitoring component may be configured to determine when a user device of the one or more user devices is attempting an action and may compare the attempted action with an associated right of the one or more rights. For example, the monitoring component may receive, an indication (e.g., a second share indication) that the second user has launched the share application 114B. The second share indication may indicate that the second user has initiated the share action with the third user (e.g., the second user is attempting to screen share, while accessing the first data file, with the third user).

It may be determined that the second user is share a screen. For example, the monitoring component may determine the second user is sharing a screen (e.g., not necessarily sharing the data file per se). For example, the monitoring component may determine that the second user has initiated a share action (e.g., sending a document, screensharing, etc.) with a third user. For example, the second user may execute a share command and select a screen (e.g., a “window) to share. The screen may be associated with a display. The display may be associated with a second user device being used by the second user. The share command may be configured to send, cause display of, or grant access to, the display of the second user device. The share application may determine that a display associated with a third user device is displaying the first data file.

Based on receiving the second share indication, it may be determined that the share right associated with the second user indicates the second user is not permitted to share the first data file. For example, the monitoring component may determine the share right associated with the second user indicates the second user is not permitted to share the first data file. Based on determining that the second user is not permitted to share the first data file, a share alert may be sent. For example, the monitoring component may send, to the first user device 110A a share alert configured to output, on the display associated with the first user device 110A an alert, or other indication indicating the second user is attempting to share the first data file. The share alert may be agnostic with respect to the intended recipient of the share action or the share alert may indicate the intended recipient of the share action.

An output of the first data file may be determined. For example, the analysis component may be configured to determine an output of the first data file. For example, the analysis component may be configured to determine the first data file has been output on the third user device. A share selection indication may be received from the second user. For example, the analysis component may receive, for example, the share selection indication from the second user. The share selection indication may be configured to indicate a selection of a window, application, or data file (e.g., the first data file) by the second user. For example, after launching the share application 114B, the share application 114B may present a share option configured to receive a user input indicating a second user associated with the second user intends to share a screen and/or share a particular data file with, for example, the third user.

It is not necessary that the analysis component determine that the first data file has been output to the third user device. For example, the analysis component may determine that the first user is sharing a screen (e.g., a display) with a non-collaborator. The analysis component may determine that the screen to be shared with the non-collaborator comprises (e.g., is displaying or otherwise outputting) the first data file. Based on the screen comprising the first data file, the computing device may cause output of the second share indication. Thus, the second share indication may be output regardless of whether the first data file is actually output (e.g., displayed) on the third user device.

If the share command is configured to share the first data file to a non-collaborator, the application 104 may output an indication in the first data file (e.g., in a document), and/or in a software application configured for viewing/editing the first data file, indicating the non-collaborator is in the first data file. The share command may be configured to facilitate access (e.g., by the third user) to the first data file. For example, the share command may comprise an identifier associated with the first data file (e.g., a document number or the like) and an identifier associated with an intended recipient. The computing device may compare the identifier associated with the intended recipient with a list of identifiers associated with one or more document collaborators. Thus, the computing device 104 may determine the first data file is being shared with a non-collaborator.

Optionally, the contents of the first data file may be determined. For example, based on a received input indicating the second user intends to share the first data file, the analysis component may determine the contents of the first data file. For example, if the first data file comprises a text file, the analysis component may determine the text of the text file (e.g., the letters, numbers, or characters etc. that make up the text file). For example, the analysis component may be configured for optical character recognition (OCR). Based on the share selection indication, the analysis component may determine the contents of the first data file and compare them to the contents of the first data file being shared with (e.g., output on a display associated with) the third user. For example, the analysis component may capture a screenshot (periodically or otherwise) of the display associated with the third user, and perform OCR on the screenshot to determine whether or not the first data file is being output on the display associated with the third user.

Optionally, it may be determined that the first data file is partially obscured. For example, the share application may determine the first data file is partially obscured. If the share application determines the first data file is partially obscured, the share application may determine, for example, a degree of obfuscation associated with the display of the first data file. For example, the share application may determine the first data file is 10% obscured, 40% obscured, 50%, 75% and so on. Optionally, the share application may determine the degree of obfuscation satisfies an obfuscation threshold. For example, the obfuscation threshold may be 75% (a person skilled in the art will appreciate that any threshold may be implemented) and that if the first data file is 75% obscured, the third user is not viewing a meaningful amount of the document. Optionally, if the degree of obfuscation fails to satisfy the obfuscation threshold, the share application may send an indication to the first application indicating that the first data file is being shared with the third user.

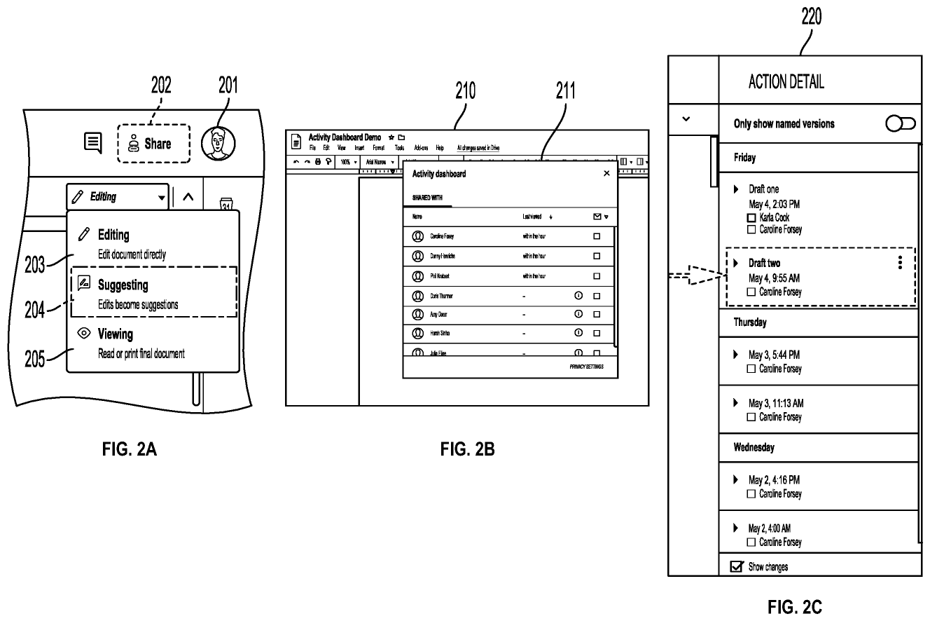

FIG. 2A shows an example user interface 200. The user interface 200 may be associated with a user device of the one or more user devices. For example, the user interface 200 may be associated with (e.g., output on) a display associated with the first user device 110A. The user interface 200 may comprise a user account indication 201. The user account indication may comprise, for example, an image or text associated with a user. The user account indication 201 may be associated with one or more user accounts. The one or more user accounts may be associated with one or more rights (e.g., one or more access rights, one or more edit rights, one or more share rights, combinations thereof, and the like) associated with a date file. The one or more user accounts may be subscription accounts, paid accounts, or the like. The user interface 200 may comprise a share option 202. The share option 202 may be a selectable option. The share option 202 may be configured to initiate a share action. The share action may comprise for example, sending the first data file to another user device such as the second user device 110B or the third user device 110C, or causing the third user device 110C to display the first data file. For example, the first user device may send an image of a window, screen, or display associated with the first user device 110A to the third user device 110C. For example, the share action may comprise a screenshare, live broadcast, recorded broadcast, combinations thereof, or the like.

The user interface 200 may indicate one or more rights associated with the user account. The one or more rights may comprise one or more access rights, one or more edit rights 203, one or more suggesting rights 204, or one or more viewing rights 205, or one or more sharing rights (e.g., by virtue of the share option 202).

FIG. 2B shows an example user interface 210. The user interface 210 may be configured to output one or more alerts 211. The one or more alerts 211 may indicate an activity history (e.g., via an activity dashboard) that may indicate one or more actions taken by one or more user devices (and/or respective one or more users associated with the one or more user devices) with respect to a data file. For example, the activity dashboard may comprise a history of actions taken with respect to the data file by the one or more users.

FIG. 2C shows an example user interface 220. The user interface 220 may comprise an action detail indicating, for example, the action detail may comprise timing information such as one or more dates or times associated with one or more actions taken (or attempted) with respect to the data file. The action detail may indicate one or more users or user accounts associated with the one or more actions or attempted actions taken with respect to the data file.

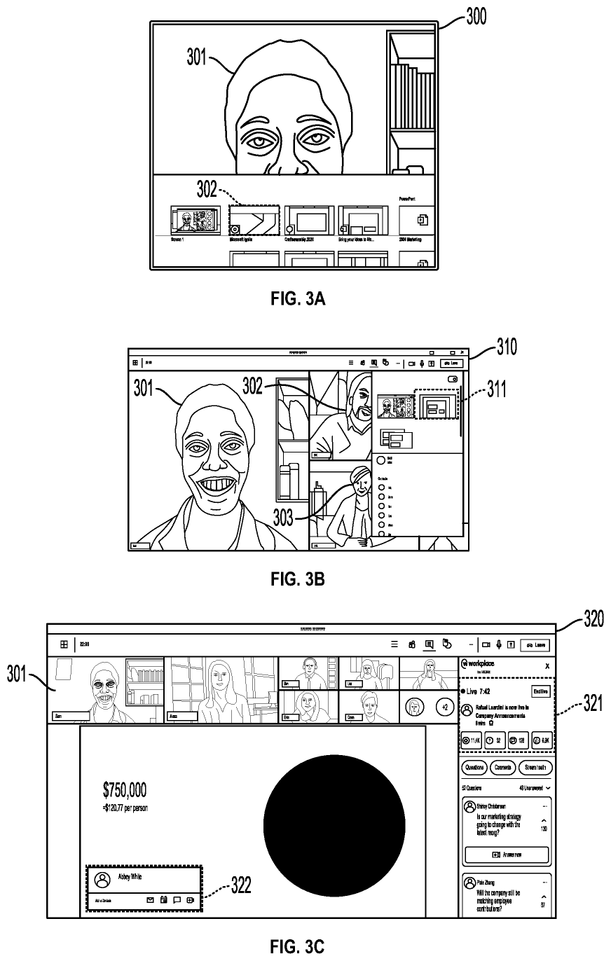

FIG. 3A shows an example user interface 300 that a first user 301 may see on a display associated with a first user device (e.g., the first user's display). The first user may select to share a document 302 with, for example two non-collaborators. FIG. 3B shows an example user interface 310 that the first user may see on the display associated with the first user device. FIG. 3B shows the first user executing a share command 311. The share command 311 may configured to share the document 302 with two non-collaborators 302 and 303. FIG. 3C shows an example user interface 320 that the first user 301 may see on the display associated with the first user device. As seen in FIG. 3C, the first user has shared the document and a plurality of non-collaborators are also able to view the document. FIG. 3C shows an alert 321 indicating a first non-collaborator is working live in the document. FIG. 3C shows an in-document alert 322 displayed on the display associated with the first user device indicating one of the non-collaborators (e.g., “Abbey White”) is in the document.

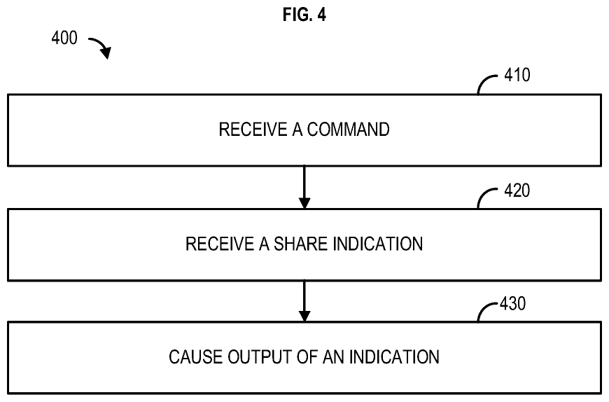

FIG. 4 shows an example method 400, executing on one or more of the devices of FIG. 1. At step 410, a command may be received. For example, the command may be received by a computing device. The command may be sent by a first user device associated with a first user. The command may be configured to grant one or more access rights associated a data file to a second user device associated with a second user.

At step 420, a share indication may be received. The share indication may be received from the second user device associated with a second user. The share indication may be received based on the second user device launching a share application or otherwise initiating a share action. The share action may comprise for example, sending the data file to a third user device, or causing the third user device to display the first data file or that the second user device is broadcasting or otherwise sending (e.g., transmitting) the data file to another user or device. For example, the share action may comprise a screen share and/or otherwise sending the data file. The share indication may comprise an indication that the second user device is attempting at least one of: sharing a screen for displaying contents of the data file, sending the data file, copying the data file, sharing the data file, or processing the data file. Receiving the share indication comprises receiving, from the second user device, image data associated with a display of the second user device, the method further comprising determining, based on the image data, contextual data associated with the data file. The share indication may also comprise user account information associated with one or more users. For example, the share indication may indicate which user shared the data file and/or which user (if any) received or otherwise accessed or viewed the data file.

At step 430, an indication may be caused to be output on an application outputting the data file. For example, the indication may comprise an indication. The indication the second user device is sharing the data file may be sent based on the share indication. The message may indicate the second user device is sharing the data file with a third user device (e.g., the third user device 110C). The message indicating the second user device is sharing the data file may comprise one or more of: an identifier associated with the data file, an identifier associated with the second user device, or an identifier associated with the third user device.

Based on a message indicating the second user device is sharing the data file, the first user device may be caused to output an alert indicating the second user device is sharing the data file. One or more rights associated with the second user device may be determined. A violation of at least one right of the one or more rights may be determined based on the share indication. Alert may be sent to the first user device. The alert may be configured to be output in the data file. A terminate command configured to cause the second user device to terminate sharing the data file may be received from the first user device.

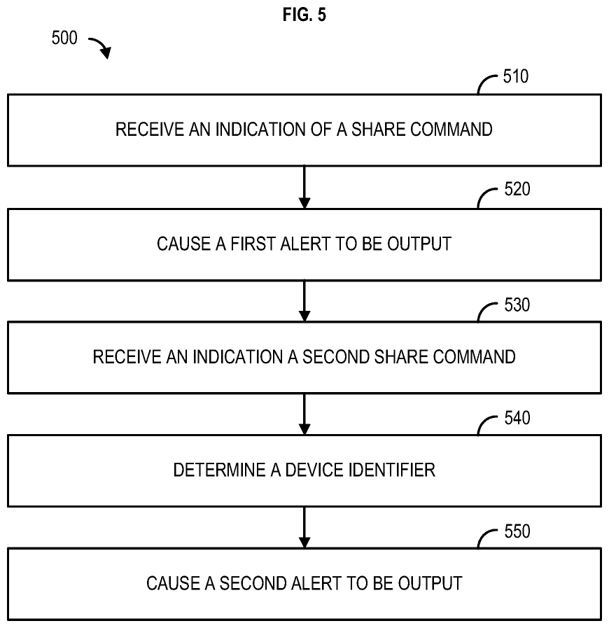

FIG. 5 shows an example method 500. For example, the method 500 may be executed on one or more of the devices of FIG. 1. At step 510, an indication of a first share command may be received. The first share command may be configured to share a data file with a second user device. For example, the indication may be received from a first device (e.g., the first user device 110A) associated with a first user. The command may be configured to grant one or more access rights associated with a data file to a second user associated with a second user device (e.g., the second user device 110B). The data file may comprise at least one of: text data, audio data, image data, multimedia content, or computer code. The one or more access rights comprise one or more of an edit right, a copy right, a send right, or a sharing prohibition. The data file comprises at least one of: text data, audio data, image data, multimedia content, or computer code. The command may be configured to cause the second user device to output the data file and outputting the data file may comprise displaying contents of the data file.

At 520, a first share alert may be output in the data file. The first share alert may comprise an indication that either or both of the first user and/or the second user are viewing, accessing, editing, or otherwise interacting with (e.g., are “in”) the data file. The first share alert may comprise an icon or message. For example, the first share alert may be configured to indicate one or more identifiers associated with the first user or the first user device or the second user or the second user device.

At 530, an indication of a second share command may be received. The indication of the second share command may be received from the second user device. The second share command may be configured to share the document with a third user. The third user may be associated with a third user device. The second share command may be configured to send, cause display of, or grant access to the data file to the third user.

At 540, a third user device identifier associated with the third user device may be determined. The third user device identifier associated with the third user device may be determined based on the second share command. For example, the second share command may comprise the third user device identifier.

At 550, a second share alert may be caused to be output. The second share alert may be output based on the third device identifier. The second share alert may be configured to indicate that the second user has shared the data file. The second share alert may be output in the data file.

One or more rights associated with second user device may be determined. A violation of at least one right of the one or more rights may be determined. Based on the violation of the one or more rights, an alert may be sent to the user device. The alert may be configured to be output in the data file. A terminate command may be received from the first user device. The terminate command configured to cause the second user device to terminate sharing the data file.

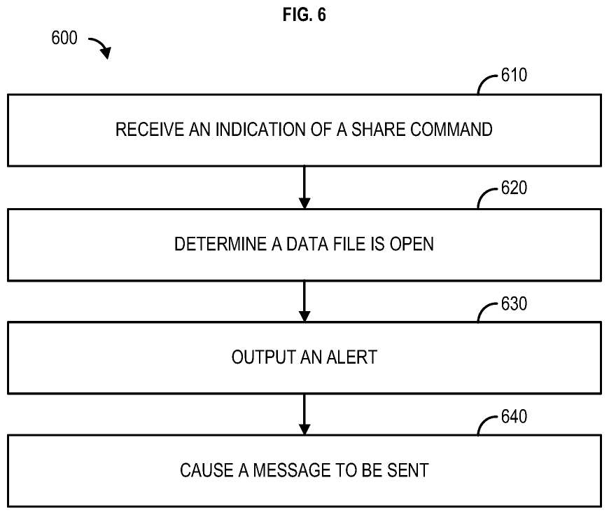

FIG. 6 shows an example method 600. For example, the method 600 may be executed on one or more of the devices of FIG. 1. At step 610, an indication of a share command may be received from a first user device associated with a first user. The share command may be configured to grant access to a data file to a second user associated with a second user device. The share command may be sent by a first user device, based on an interaction received via a user interface associated with the first user device. The share command may configured to cause the second user device to output the data file. For example, outputting the data file may comprise at least one of: displaying contents of the data file, sending the data file, copying the data file, or processing the data file.

At 620, it may be determined that the data file is open on the first user device. For example, the first user device may be outputting (e.g., displaying) the data file.

At 630, an alert may be output. The alert may be output via the first user device. The alert may be configured to indicate that the second user device has initiated a share command configured to share the data file with a third user device. For example, the second user device and the third user device may be in a video conference and the share command may comprise a screenshare. The third user device may not be an authorized device. For example, the third user device may not be associated with one or more access rights associated with the data file

At 640, a message may be caused to be sent to the second user device. The message may be sent to the second user device based on the third user device (and/or a third user associated therewith) not being authorized to view or otherwise access the data file. The message may be configured to cause the second user device to stop sharing the data file.

A termination confirmation may be received form the second user device. At least one rights request may be received from the second user device. The at least one rights request may comprise an identifier associated with the second user device. Based on the at least one rights request, and the identifier associated with the second user device, one or more rights associated with the second user device may be determined.

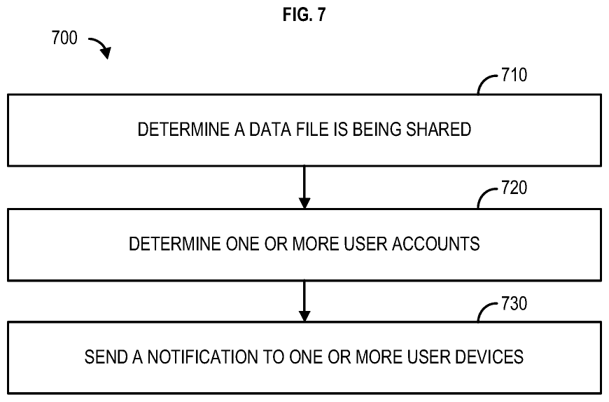

FIG. 7 shows an example method 700. For example, the method 700 may be executed on one or more of the devices of FIG. 1. At step 710, it may be determined that a data file is being shared. The data file may comprise at least one of: text data, audio data, image data, multimedia content, or computer code. For example, the monitoring component may receive, an indication (e.g., a share indication) that a second user device has launched a share application. The share indication may indicate that the second user device has initiated the share action with the third user device (e.g., the second user device is attempting to screen share, while accessing the first data file, with the third user device).

At step 720, one or more user accounts with access rights to the data file may be determined. The one or more user accounts with access rights to the data file may be determined based on the determination that the data file is being shared. For example, upon receiving the share indication, the monitoring component may query a DMS to determine the one or more user accounts and one or more user device identifiers associated with the one or more user accounts. The one or more user accounts may be subscription accounts, paid accounts, or the like. Determining the one or more user accounts have access rights to the data may comprise determining a security setting and/or security clearance level associated any one of the one or more user accounts.

At step 730, a notification to the one or more user devices associated with the one or more user accounts may be sent. The notification may indicate the data file is being shared. For example, based on receiving the share indication, the monitoring component may determine the share right associated with the second user device indicates the second user device is not permitted to share the data file. Based on determining that the second user device is not permitted to share the data file, the monitoring component may send, to a first user device a share alert configured to output, on the display associated with the first user device an alert, or other indication indicating the second user device is attempting to share the first data file. The share alert may be agnostic with respect to the intended recipient of the share action or the share alert may indicate the intended recipient of the share action.

At least one rights request comprising an identifier associated with the second user device may be received from the second user device. One or more rights associated with the second user device may be determined based on the at least one rights request and the identifier associated with the second user device. Contextual data associated with the display may be determined. An identifier associated with the data file may be determined based on the contextual data associated with the display.

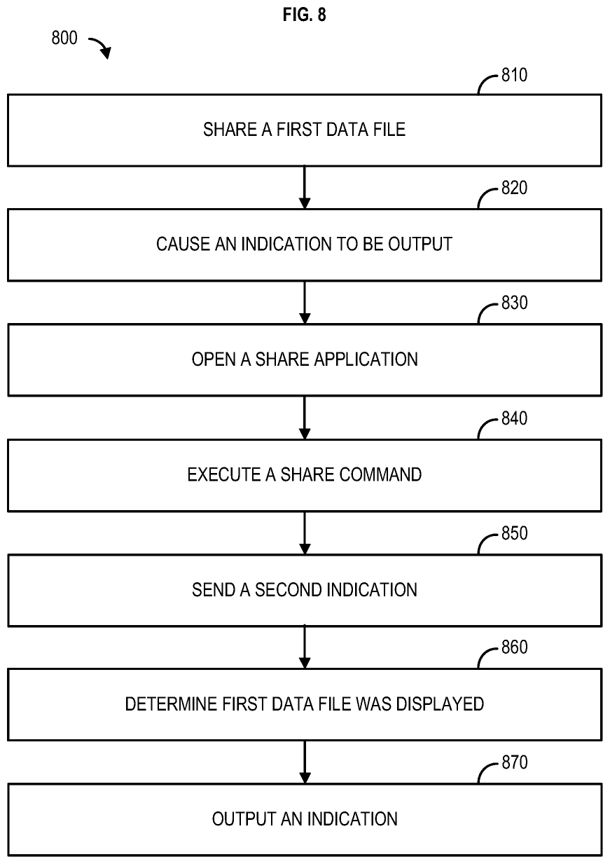

FIG. 8 shows an example method 800. At 810, a first user working in a first application (e.g., a word processing application) on a first data file (e.g., a word document) may share the first data file with a second user. For example, the first use may execute a share command. For example, a user may initiate the share command via a user interface comprising a selectable option. The share command may be configured to share a data file. The data file may comprise, for example, a document (e.g., a Word document, an Excel Spreadsheet, a Google doc, a PowerPoint, or any other type of data file). For example, the share command may be configured to send the data file, grant access to the data file, or cause output of the data file. For example, the share command may be configured to cause a document which is presently displayed on a display of a first user device, to be displayed on a display of a second user device. For example, the first user and the second may be editing or otherwise interacting with (e.g., “in”) the data file.

At 820, the first application may cause an indication to be output on the first data file. For example, the indication may be displayed in the document (e.g., visible to either or both of the first user and/or the second user) indicating that the other user is in the document.

At 830, the second user may open a share application (e.g., a video conferencing application) configured to share (e.g., send, display, cause display) of the data file to a third user (e.g., cause display of the data file on a third user device). A third user may also be associated with the share application. For example, the second user and the third user may participate in the video conference. The third user may not be associated with the first share command

At 840, the second user may execute a share command and select the data file to be shown to the third user via the videoconference. The share command may be configured to send, cause display of, or grant access to, the first data file to the third user. For example, the share command may cause a display associated with the third user (e.g., a display of a third user device) to output (e.g., display) the data file.

At 850, the share application may send an indication to the first application (e.g., the word processing application) indicating that the third user was shared the first document via the share application. The indication may indicate the user who shared the document (e.g., the second user) as well as the user who received the share (e.g., the third user). The indication may indicate the method of sharing (e.g., screensharing, document sharing, transmitting, granting access, etc.).

At 860, the first application may determine that the first data file was shown to the third user who was not shared the document via the first application for editing purposes (e.g., the third user is a “non-collaborator”). For example, the first application may receive, from the share application, a user identifier associated with the third user, a third user device identifier associated with the third user device, combinations thereof, and the like. The first application may compare the third user identifier and/or the third user device identifier to a database and determine that the third user is a non-collaborator.

At 870, based on determining that the first data file was shown to a non-collaborator, the first application may cause a second indication to the be output on the first data file. The second indication may indicate that the third user is viewing the first data file. For example, the second indication may comprise an eye or other icon indicating that the third user is viewing (but not editing or otherwise “in” the document). For example, the second indication may display an identifier associated with either or both of the third user and/or the third user device.

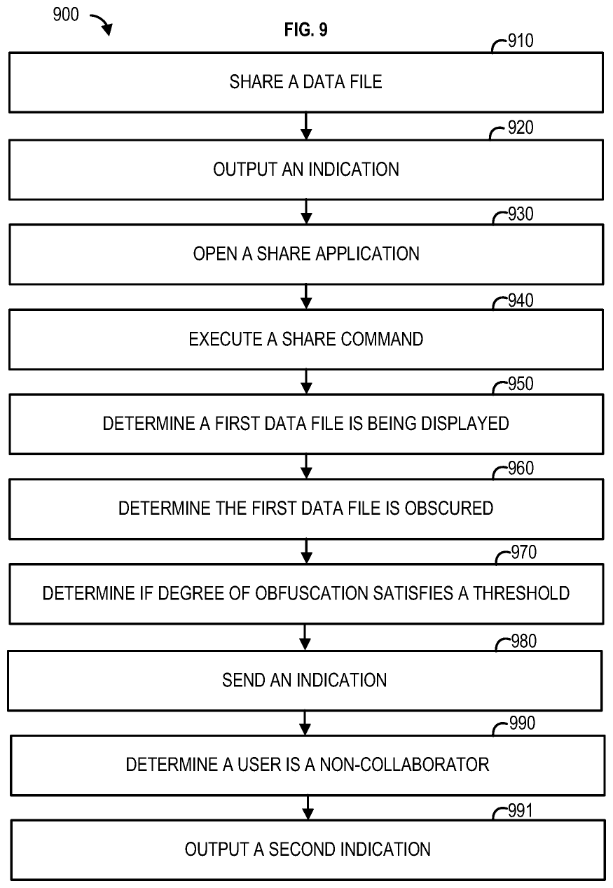

FIG. 9 shows an example method 900. At 910, a first user working in a first application (e.g., a word processing application) on a first data file (e.g., a word document) may share the first data file with a second user. For example, the first use may execute a share command. For example, a user may initiate the share command via a user interface comprising a selectable option. The share command may be configured to share a data file. The data file may comprise, for example, a document (e.g., a Word document, an Excel Spreadsheet, a Google doc, a PowerPoint, or any other type of data file). For example, the share command may be configured to send the data file, grant access to the data file, or cause output of the data file. For example, the share command may be configured to cause a document which is presently displayed on a display of a first user device, to be displayed on a display of a second user device. For example, the first user and the second may be editing or otherwise interacting with (e.g., “in”) the data file.

At 920, the first application may cause an indication to be output on the first data file. For example, the indication may be displayed in the document (e.g., visible to either or both of the first user and/or the second user) indicating that the other user is in the document.

At 930, the second user may open a share application (e.g., a video conferencing application) configured to share (e.g., send, display, cause display) of the data file to a third user (e.g., cause display of the data file on a third user device). A third user may also be associated with the share application. For example, the second user and the third user may participate in the video conference.

At 940, the second user may execute a share command and select a screen (e.g., a “window) to share. The screen may be associated with a display. The display may be associated with a second user device being used by the second user. The share command may be configured to send, cause display of, or grant access to, the display of the second user device.

At 950, the share application may determine that the display associated with the third user device is displaying the first data file. For example, the share application may perform object recognition, OCR or any other technique to determine that the third user device is displaying the first data file. At 960, the share application may optionally determine the first data file is partially obscured. If the share application determines the first data file is partially obscured, the share application may determine, for example, a degree of obfuscation associated with the display of the first data file. For example, the share application may determine the first data file is 10% obscured, 40% obscured, 50%, 75% and so on. Optionally, at 970, the share application may determine the degree of obfuscation satisfies an obfuscation threshold. For example, the obfuscation threshold may be 75% (a person skilled in the art will appreciate that any threshold may be implemented) and that if the first data file is 75% obscured, the third user is not viewing a meaningful amount of the document. At 980, if the degree of obfuscation fails to satisfy the obfuscation threshold, the share application may send an indication to the first application indicating that the first data file is being shared with the third user.

At 990, the first application may determine the third user is a non-collaborator. For example, the share application may send, to the first application one or more identifiers. For example, the one or more identifiers may comprise a user identifier associated with the third user, a third user device identifier associated with the third user device, combinations thereof, and the like. The first application may compare the one or more identifiers to a list of one or more identifiers associated with collaborators and determine the third user is a non-collaborator.

At 991, based on the determination that the first data file was shared with a non-collaborator, the first application may cause a second indication to be output on (e.g., “in”) the data file. For example, the second indication may be configured to indicate that the data file was shared with a non-collaborator. The second indication may indicate that the third user is viewing the first data file. For example, the second indication may comprise an eye or other icon indicating that the third user is viewing (but not editing or otherwise “in” the document). For example, the second indication may display an identifier associated with either or both of the third user and/or the third user device.

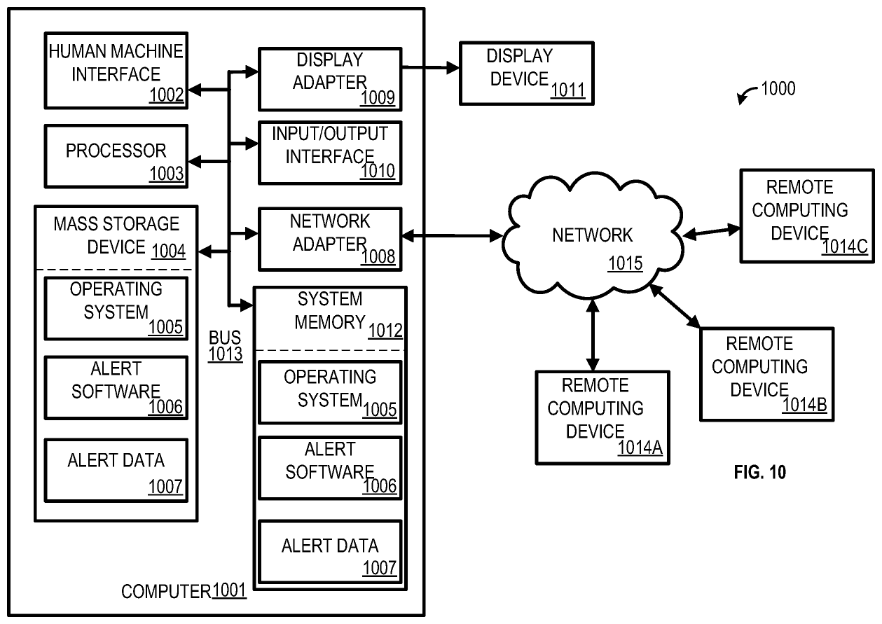

The above described disclosure may be implemented on a computer 1001 as illustrated in FIG. 10 and described below. FIG. 10 is a block diagram illustrating an example operating environment for performing the disclosed methods. This example operating environment is only an example of an operating environment and is not intended to suggest any limitation as to the scope of use or functionality of operating environment architecture. Neither should the operating environment be interpreted as having any dependency or requirement relating to any one or combination of components illustrated in the example operating environment.

The present disclosure can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Examples comprise set top boxes, programmable consumer electronics, network PCs, minicomputers, mainframe computers, distributed computing environments that comprise any of the above systems or devices, and the like.

The processing of the disclosed can be performed by software components. The disclosed systems and methods can be described in the general context of computer-executable instructions, such as program components, being executed by one or more computers or other devices. Generally, program components comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program components can be located in both local and remote computer storage media including memory storage devices.

Further, one skilled in the art will appreciate that the systems and methods disclosed herein can be implemented via a general-purpose computing device in the form of a computer 1001. The components of the computer 1001 can comprise, but are not limited to, one or more processors 1003, a system memory 1012, and a system bus 1013 that couples various system components including the one or more processors 1003 to the system memory 1012. The system can utilize parallel computing.

The system bus 1013 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1013, and all buses specified in this description can also be implemented over a wired or wireless network connection and each of the subsystems, including the one or more processors 1003, a mass storage device 1004, an operating system 1005, alert software 1006, alert data 1007, a network adapter 1008, the system memory 1012, an Input/Output Interface 1010, a display adapter 1009, a display device 1011, and a human machine interface 1002, can be contained within one or more remote computing devices 1014A, 1014B, 1014C at physically separate locations, connected through buses of this form, in effect implementing a fully distributed system.

The computer 1001 typically comprises a variety of computer readable media. Example readable media can be any available media that is accessible by the computer 1001 and comprises, for example and not meant to be limiting, both volatile and non-volatile media, removable and non-removable media. The system memory 1012 comprises computer readable media in the form of volatile memory, such as random access memory (RAM), and/or non-volatile memory, such as read only memory (ROM). The system memory 1012 typically contains data such as the alert data 1007 and/or program components such as the operating system 1005 and the alert software 1006 that are immediately accessible to and/or are presently operated on by the one or more processors 1003.

The computer 1001 can also comprise other removable/non-removable, volatile/non-volatile computer storage media. By way of example, FIG. 10 illustrates the mass storage device 1004 which can facilitate non-volatile storage of computer code, computer readable instructions, data structures, program components, and other data for the computer 1001. For example and not meant to be limiting, the mass storage device 1004 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program components can be stored on the mass storage device 1004, including by way of example, the operating system 1005 and the alert software 1006. Each of the operating system 1005 and the alert software 1006 (or some combination thereof) can comprise elements of the programming and the computing task software 1006. The alert data 1007 can also be stored on the mass storage device 1004. The alert data 1007 can be stored in any of one or more databases known in the art. Examples of such databases comprise, DB2®, Microsoft® Access, Microsoft® SQL Server, Oracle®, mySQL, PostgreSQL, Mongo, Cassandra, and the like. The databases can be centralized or distributed across multiple systems.

The user or device can enter commands and information into the computer 1001 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 1003 via the human machine interface 1002 that is coupled to the system bus 1013, but can be connected by other interface and bus structures, such as a parallel port, game port, an IEEE 1394 Port (also known as a Firewire port), a serial port, or a universal serial bus (USB).

The display device 1011 can also be connected to the system bus 1013 via an interface, such as the display adapter 1009. It is contemplated that the computer 1001 can have more than one display adapter 1009 and the computer 1001 can have more than one display device 1011. For example, the display device 1011 can be a monitor, an LCD (Liquid Crystal Display), an augmented reality (AR) display, a virtual reality (VR) display, a projector, combinations thereof, and the like. In addition to the display device 1011, other output peripheral devices can comprise components such as speakers (not shown) and a printer (not shown) which can be connected to the computer 1001 via the Input/Output Interface 1010. Any step and/or result of the methods can be output in any form to an output device. Such output can be any form of visual representation, including, but not limited to, textual, graphical, animation, audio, tactile, and the like. The display device 1011 and computer 1001 can be part of one device, or separate devices.

The computer 1001 can operate in a networked environment using logical connections to one or more remote computing devices 1014A, 1014B, 1014C. By way of example, a remote computing device can be a gaming system, personal computer, portable computer, smartphone, a server, a router, a network computer, a peer device or other common network node, and so on. Logical connections between the computer 1001 and a remote computing device 1014A, 1014B, 1014C can be made via a network 1015, such as a local area network (LAN) and/or a general wide area network (WAN). Such network connections can be through the network adapter 1008. The network adapter 1008 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1005 are illustrated herein as discrete blocks, although it is recognized that such programs and components reside at various times in different storage components of the computing device 1001, and are executed by the one or more processors 1003 of the computer. An implementation of the alert software 1006 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program components, or other data. Example computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The disclosure can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the disclosure has been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as an example only, with a true scope and spirit being indicated by the following claims.

What is claimed is:

1. A method comprising:
receiving, from a second user device associated with the second user, a share indication associated with a data file, wherein the second user device has access to the data file shared by a first user device associated with a first user; and
causing, based on the share indication, an indication to be output on an application outputting the data file, wherein the indication indicates that the second user device is sharing the data file with a third device associated with a third user.

2. The method of claim 1, wherein the share indication comprises an indication that the second user device is attempting at least one of: sharing the data file, sharing a screen presently outputting contents of the data file, sending the data file, copying the data file, sharing the data file, or processing the data file.

3. The method of claim 1, wherein the share indication comprises one or more of: an identifier associated with the data file, an identifier associated with the second user device, or an identifier associated with a third user device.

4. The method of claim 1, wherein receiving the share indication comprises receiving, from the second user device, image data associated with an output of the second user device, the method further comprising determining, based on the image data, contextual data associated with the data file.

5. The method of claim 1, further comprising causing, based on the indication the second user device is sharing the data file, the first user device to output an alert indicating the second user device is sharing the data file.

6. The method of claim 1, further comprising:
determining one or more rights associated with the second user device;
determining, based on the share indication, a violation of at least one right of the one or more rights; and
sending, to the first user device, an alert.

7. The method of claim 1, further comprising receiving, from the first user device, a terminate command configured to cause the second user device to terminate sharing the data file.

8. A method comprising:
causing, based on an indication of a first share command from first user device associated with a first user, a first share alert to be output in the data file, wherein the first share command is configured to share a data file with a second user;
receiving, from a second user device associated with the second user, an indication of a second share command configured to share the data file with a third user;
determining based on the indication of the second share command, a third user device identifier associated with the third user; and
causing, based on the third user device identifier, a second share alert to be output in an application outputting the data file.

9. The method of claim 8, wherein the first share command comprises an access command and wherein the second share command comprises a screenshare command.

10. The method of claim 8, wherein the first share alert comprises an indication that a second user associated with the second user device is accessing the data file.

11. The method of claim 8, wherein the second share alert comprises an indication that a third user device associated with the third user device identifier is outputting the data file, wherein the third user is not associated with the first share command.

12. The method of claim 11, further comprising:
determining the third user device is not authorized to access the data file; and
based on the third user device not being authorized to access the data file, sending an alert to the first user device.

13. The method of claim 8, wherein causing the second share alert to be output in the data file comprises causing an icon to be displayed in the data file.

14. The method of claim 8, further comprising:
determining contextual data associated a display of the second user device; and
determining, based on the contextual data associated with the display, an identifier associated with the data file.

15. A method comprising:
receiving from a first user device associated with a first user, an indication of a share command, wherein the share command is configured to share a data file with a second user;
outputting, via the first user device, and based on a determination that the data file is currently open on the first user device, an alert on the data file indicating that the second user is sharing the data file via a video conference with a third user, wherein the third user is not an authorized user; and
causing, based on the third user not being an authorized, a message to be sent to a second user device associated with the second user, wherein the message is configured to cause the second user device to stop sharing the data file.

16. The method of claim 15, wherein the indication of the share command comprises a message comprising one or more of: a first user device identifier associated with the first use device, a second user device identifier associated with the second user device, and a data file identifier associated with the data file.

17. The method of claim 15, wherein the share command comprises one or more of: sending the data file to the second user device, granting access to the data file to the second user device, or screensharing with the second user device.

18. The method of claim 15, further comprising receiving, from the second user device, a termination confirmation.

19. The method of claim 15, wherein the share command is configured to cause a second user device to output the data file and wherein outputting the data file may comprise at least one of: displaying contents of the data file, sending the data file, copying the data file, or processing the data file.

20. The method of claim 15, further comprising:
receiving, from the second user device, at least one rights request comprising an identifier associated with the second user device; and
determining, based on the at least one rights request and the identifier associated with the second user device, one or more rights associated with the second user device.
